(19) United States
(12) Patent Application Publication
(10) Pub. No.: US 2015/0019592 A1
(43) Pub. Date: Jan. 15, 2015

(54) SYSTEMS, METHODS AND SOFTWARE FOR COMPUTING REACHABILITY IN LARGE GRAPHS

(71) Applicant: Kent State University, Kent, OH (US)

(72) Inventors: Ruoming Jin, Streetsboro, OH (US); Ning Ruan, Santa Clara, CA (US)

(21) Appl. No.: 14/382,784

(22) PCT Filed: Mar. 13, 2013
(86) PCT No.: PCT/US13/30791

§ 371 Date: Sep. 4, 2014

Related U.S. Application Data
(60) Provisional application No. 61/609,961, filed on Mar. 13, 2012.

(51) Int. Cl. G06F 17/30; G06F 17/10

(52) U.S. Cl. CPC G06F 17/30958; G06F 17/10
USPC 707/798

(57) ABSTRACT

Embodiments disclosed herein provide systems and methods for scaling reachability computations on relatively large graphs. In an embodiment, a method provides for scaling reachability computations on relatively large graphs, the method comprising, identifying an initial graph comprising a plurality of vertices and a plurality of edges, processing at least a portion of the plurality of vertices and at least a portion of the plurality of edges to generate a plurality of reachability indices for the at least a portion of the plurality of vertices, and generating a backbone graph comprising a scaled-down version of the initial graph, based at least in part on at least one of the plurality of reachability indices.

### RELATED APPLICATIONS

This application hereby claims the benefit of, and priority to, U.S. Provisional Patent Application 61/609,961, titled “A METHOD FOR DATA ACQUISITION, INPUT, ANALYSIS, QUERY AND RETRIEVAL, EMPLOYING SCALING REACHABILITY COMPUTATIONS ON VERY LARGE GRAPHS”, filed Mar. 13, 2012, and which is hereby incorporated by reference in its entirety for all purposes.

### TECHNICAL BACKGROUND

A relational database system is a collection of data items organized as a set of formally described tables from which data can be accessed. These relational databases can become very large, and the response to any query of these databases may require accessing a multitude of databases, each of which may be partially responsive to the query.

Many relational databases, such as in social networks, grow rapidly as data changes with respect to participants and their various natures, features, qualities, and the like. Such a network may be represented by a massive graph, where nodes are connected by edges to other nodes, and both the nodes and edges represent associated relational data.

Previously, the searching of these graphs has been laborious, time consuming, and inordinately and exhaustively detailed, requiring the individual treatment and assessment of each of a multiplicity of nodes and edges. Thus, there is a need for a more effective, efficient, and inexpensive structure, technique, and methodology for undertaking a query in such graphs and networks.

Furthermore, graph data can be stored in a graph database, and the methods and systems described herein can be used on either a graph database, and/or a relational database.

### OVERVIEW

Embodiments disclosed herein provide systems and methods for scaling reachability computations on relatively large graphs. In an embodiment, a method provides for scaling reachability computations on relatively large graphs, the method comprising identifying an initial graph comprising a plurality of vertices and a plurality of edges, identifying a backbone graph within the initial graph, creating a subsequent scaled-down version of the initial graph, based at least in part on the backbone graph, and computing the reachability of at least two of the vertices using at least the subsequent graph.

In another embodiment, one or more computer readable storage media having program instructions stored thereon for scaling reachability computations on relatively large graphs that, when executed by a computing system, direct the computing system to at least identifying an initial graph comprising a plurality of vertices and a plurality of edges, identifying a backbone graph within the initial graph, creating a subsequent scaled-down version of the initial graph, based at least in part on the backbone graph, and computing the reachability of at least two of the vertices using at least the subsequent graph.

### BRIEF DESCRIPTION OF THE DRAWINGS

FIG. 1 illustrates a method for scaling reachability computations according to one example.

FIG. 2 illustrates a computing system capable of scaling reachability computations according to one example.

FIG. 3 illustrates an environment for scaling reachability computations according to an example.

FIG. 4 illustrates an initial graph according to an example.

FIG. 5 illustrates a scaled-down, subsequent, and/or backbone graph according to an example.

### DETAILED DESCRIPTION

The following description and associated figures teach the best mode of the invention. For the purpose of teaching inventive principles, some conventional aspects of the best mode may be simplified or omitted. The following claims specify the scope of the invention. Note that some aspects of the best mode may not fall within the scope of the invention as specified by the claims. Thus, those skilled in the art will appreciate variations from the best mode that fall within the scope of the invention. Those skilled in the art will appreciate that the features described below can be combined in various ways to form multiple variations of the invention. As a result, the invention is not limited to the specific examples described below, but only by the claims and their equivalents.

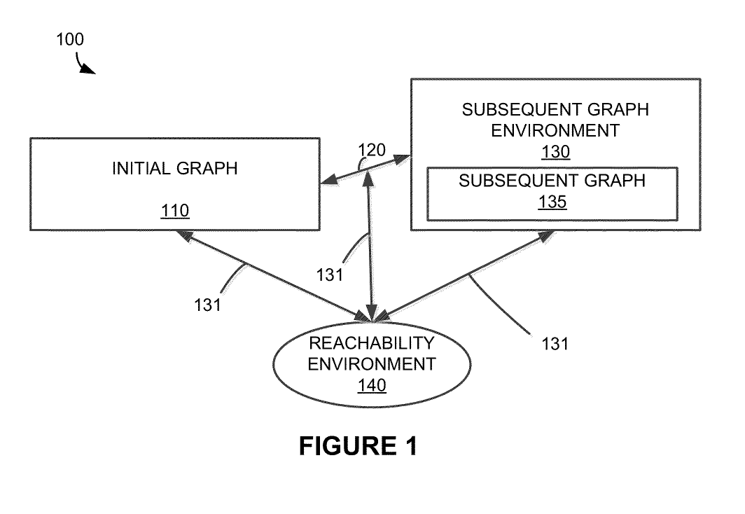

FIG. 1 illustrates a graph reachability environment 100 according to one example. Graph reachability environment 100 includes an initial graph 110, backbone identification or graph 120, subsequent/backbone graph environment 130, and reachability environment 140.

Initial graph 110 may comprises vertices and edges. It may include relational database characteristics. Reachability environment 140 can comprise one or more computer systems configured to query and/or use information from the initial graph 110, backbone 120, and/or subsequent graph 130. Examples of reachability environment 140 can include desktop computers, laptop computers, or any other like device.

An initial graph 110 may be identified. A computing system at subsequent graph environment 130 or reachability environment 140 may then identify a backbone 120. The backbone 120 can be used to create a scaled down, subsequent/backbone graph 135 in subsequent graph environment 130.

Reachability environment 140 may then compute a reachability of vertices within the initial graph 110, using at least one of the initial graph 110, backbone 120, subsequent graph environment 130, and/or subsequent graph 135.

Subsequent graph 135 may be a scaled down version of initial graph 110, such that it may be searched more quickly than initial graph 110. Furthermore, reachability may be calculated faster than reachability within initial graph 110.

Reachability environment 140 may communicate with initial graph 110, backbone 120, and/or subsequent graph environment 130. Reachability environment 140 comprises one or more computer systems configured to compute reachability of the vertices of the initial graph using the initial graph 110 and the subsequent graph 135. Reachability environment 140 and subsequent graph environment 130 can include server computers, desktop computers, laptop computers, or any other similar device—including combinations thereof.

Communication links 131 can use metal, glass, air, space, or some other material as the transport media. Communication links 131 may use various communication protocols, such as Internet Protocol (IP), Ethernet, communication signaling or any other communication format—including combinations thereof.

Although initial graph 110, subsequent graph environment 130, and reachability environment 140 are illustrated as separate environments, graph reachability environment 100 may be implemented in any number of environments, or configurations and may be implemented using any number of computing systems.

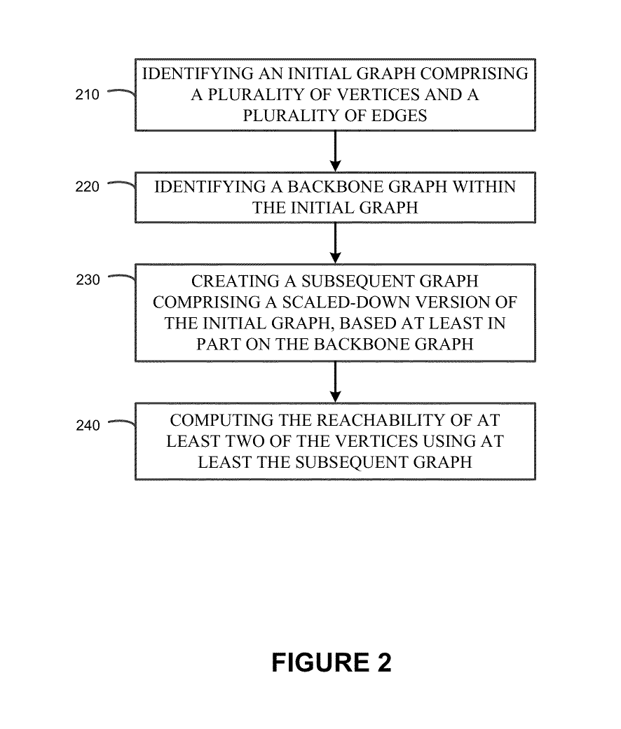

FIG. 2 illustrates a method for graph reachability environment 100 according to one example. In operation reachability environment 140 can identify an initial graph 110, which can include vertices and edges (step 210). In some examples reachability environment 140 can calculate if vertices can be reached. Such calculations can include a function designed to find if there is a path between one item in relational data (a vertice) to another data item in relational data (a second vertice).

Reachability environment 140 and/or subsequent graph environment 130 can identify a backbone graph 120 within the initial graph 110 (step 220). The backbone 120 may be identified using a number of methods, which can include a set cover method and/or a fast cover method and others as described later in this disclosure.

Reachability environment 140 and/or subsequent graph environment 130 can create a subsequent graph 135 comprising a scaled down version of the initial graph 110, using at least the backbone 120 identified in step 220 (step 230). In an example, subsequent graph 135 may include only non-local vertices. Non-local vertices can be vertices further away than a locality threshold from a particular vertice. All vertices may be included in the initial graph 110.

Reachability environment 140 and/or subsequent graph environment 130 can compute the reachability of vertices using at least the subsequent graph 135 (step 240). In an example, reachability environment 140 will calculate the reachability of at least two vertices by using a bidirectional breadth first search the initial graph 110 for local vertices, and the backbone 120 and/or subsequent graph 135 for non-local vertices. Many search techniques and method may be used for searching the subsequent graph 135, as described later in this disclosure.

If the reachability cannot be computed for the local pair within the initial graph 110, then the reachability can be computed for non-local vertices using the backbone 120 and/or the subsequent graph 135. The reachability of vertices can depend on a function of the vertices a particular vertice can reach, and a function of the vertices than can reach the particular vertice. The reachability may also depend on whether vertices can reach the backbone. The reachability of non-local vertices may also be computed in a variety of methods, as described later in this disclosure.

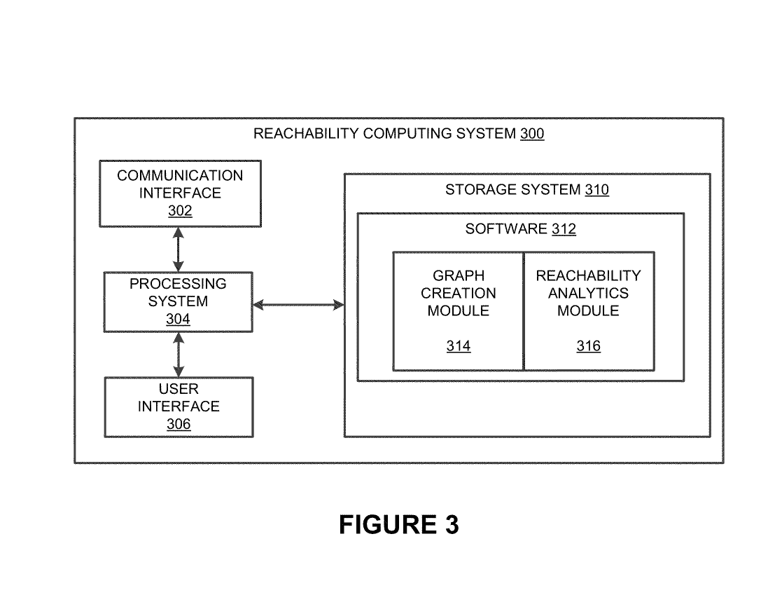

FIG. 3 illustrates a reachability computing system 300 according to one example. Reachability environment 300 can include communication interface 302, processing system 304, user interface 306, storage system 310, and software 312. Processing system 304 loads and executes software 312 from storage system 310.

Software 312 can include graph creation module 314 and reachability analytics module 316. Software 312 may further include an operating system, utilities, drivers, network interfaces, applications, or some other type of software. When executed by unified reachability computing system 300, software modules 314 and 316 direct processing system 304 to operate as a reachability environment as described as in FIG. 2 and the rest of this disclosure.

Although unified reachability computing system 300 includes two software modules in the present example, it should be understood that any number of modules could provide the same operation. Communication interface 302 can communicate using Internet Protocol (IP), Ethernet, communication signaling, or any other communication format.

Referring still to FIG. 3, processing system 304 can comprise a microprocessor and other circuitry that retrieves and executes software 312 from storage system 310. Processing system 304 can be implemented within a single processing device but can also be distributed across multiple processing devices or sub-systems, such as subsequent graph environment 130 and Reachability environment 140, that cooperate in executing program instructions. Examples of processing system 304 include general-purpose central processing units, application specific processors, and logic devices, as well as any other type of processing device, combinations of processing devices, or variations thereof.

Storage system 310 can comprise any storage media readable by processing system 304, and capable of storing software 312. Storage system 310 can include volatile and nonvolatile, removable and non-removable media implemented in any method or technology for storage of information, such as computer readable instructions, data structures, program modules, or other data. Storage system 310 can be implemented as a single storage device but may also be implemented across multiple storage devices or sub-systems. Storage system 310 can comprise additional elements, such as a controller, capable of communicating with processing system 304.

Examples of storage media include random access memory, read only memory, magnetic disks, optical disks, flash memory, virtual memory, and non-virtual memory, magnetic cassettes, magnetic tape, magnetic disk storage or other magnetic storage devices, or any other medium which can be used to store the desired information and that may be accessed by an instruction execution system, as well as any combination or variation thereof, or any other type of storage media. In some implementations, the storage media can be a non-transitory storage media. In some implementations, at least a portion of the storage media may be transitory. It should be understood that in no case is the storage media a propagated signal.

User interface 306 can include a mouse, a keyboard, a camera, a voice input device, a touch input device for receiving a gesture from a user, a motion input device for detecting non-touch gestures and other motions by a user, and other comparable input devices and associated processing elements capable of receiving user input from a user. Output devices such as a graphical display, speakers, printer, haptic devices, and other types of output devices may also be included in user interface 306. The aforementioned user input and output devices are well known in the art and need not be discussed at length here. In some examples, user interface 306 can be omitted.

It should be understood that although reachability computing system 300 is illustrated as a single system for simplicity, the system can comprise one or more systems. For example, in some embodiments graph creation module 314 and reachability analytics module 316 may be divided into separate systems.

Reachability computing system 300 may be used in conjunction with, or be an example of, reachability environment 140 and/or subsequent graph environment 130.

In at least one example, the reachability analytics module 316 may include a reachability function. Such a function will determine if a path exists between one data item to another data item in initial graph 110, backbone 120, and/or subsequent graph 135.

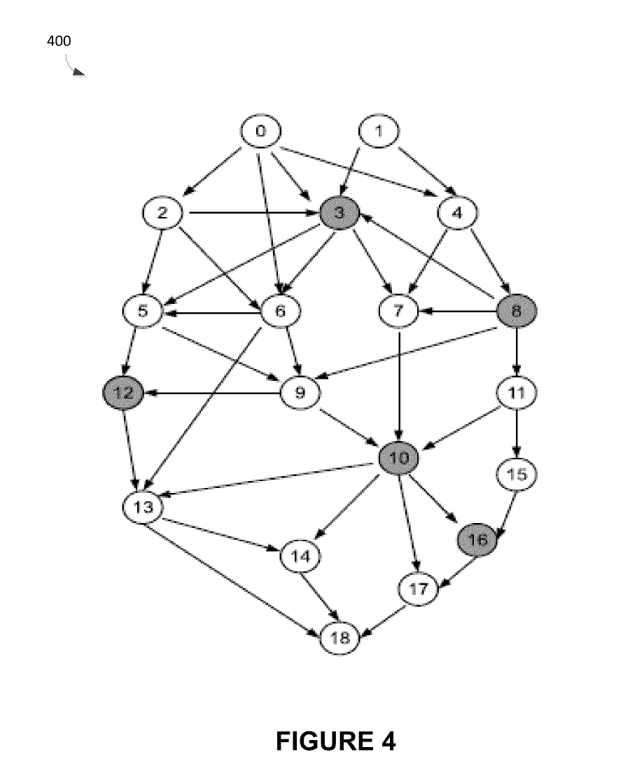

FIG. 4 illustrates an initial graph 400 according to an example. Initial graph 400 is relatively small for illustrative purposes, having only 19 nodes. An actual initial graph may be much larger.

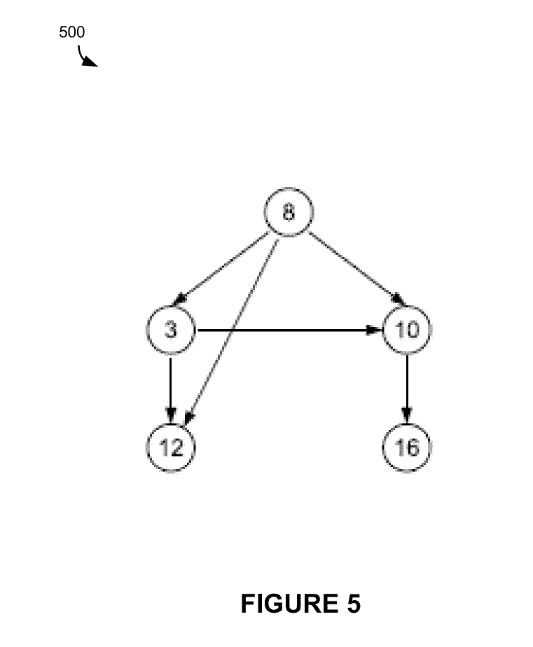

FIG. 5 illustrates an example subsequent/scaled-down/backbone graph of the example initial graph 400 in FIG. 4. FIG. 5 shows a reachability backbone of the graph in FIG. 4 with the locality threshold [symbol] =2. As an example, for non-local vertex pair (1, 18), there is a backbone vertex 3 where vertex 1 reaches 3 in one hop, there is another backbone vertex 10 where vertex 10 reaches 18 in two hops, and vertex 3 reaches 10 in the reachability backbone. Indeed, for any non-local vertex pair in FIG. 4, you can find their corresponding local backbone vertices and they are connected in the backbone and/or subsequent graph in FIG. 5.

On the other hand, if two vertices cannot reach one another, no additional connection in the backbone will make them reachable from one to another. In other words, there are no false positives for reachability using the reachability backbone. Therefore, the size and composition of the backbone and subsequent graph 500 depends on the locality threshold [symbol] .

As is shown in the empirical study Section 5, for any real and synthetic graphs, a reachability backbone with [symbol] ≦4 can already significantly reduce the size of the original initial graph by an order of magnitude. Also, for almost all the real graphs which are publicly available for reachability study, the reachability backbone even for [symbol] =2 can reduce the number of vertices by one to two orders of magnitude.

Reachability can be computed on the initial graph 400 for local vertices, and in the subsequent graph 500 for non-local pairs.

In FIG. 5, the edge set of the reachability backbone is a valid backbone edge set for the backbone vertex set {3, 8, 10, 12, 16}. However, it is not a canonical backbone edge set. If the redundant edges ((8, 10) and (8, 12)) are removed, then the resulting edge set is a canonical one as any further edge removal will disconnect some reachability pair in the original graph.

In a particular example, the systems and environments of FIGS. 1-5 use a backbone for scaling down very large graphs, and graph analytics and has the following unique features:

Reachability analysis and calculation is performed by a graph engine in a graph environment, al executed by a computing system.

Most of the existing reachability indices perform well on small- to medium-size graphs, but reach a scalability bottleneck around one million vertices/edges. As graphs become increasingly large, scalability is quickly becoming the major research challenge for the reachability computation today. Proposed is a graph calculation method and system referred to as SCARAB (standing for SCAlable ReachABility), a unified reachability computation framework: it not only can scale the existing state-of-the-art reachability indices, which otherwise could only be constructed and work on moderate size graphs, but also can help speed up the online query answering approaches. Our experimental results demonstrate that SCARAB can perform on graphs with millions of vertices/edges and is also relatively much faster than GRAIL, the state-of-the-art scalability index approach.

Reachability is a fundamental operator on directed graphs. It answers whether a vertex u can reach another vertex v using a simple path (?u→v). Computing reachability has been studied in a wide range of computer science disciplines, including software engineering, programming languages, and distributed computing.

Early work on reachability in the database field dates back to its application to the recursion operator and knowledge management The recent emergence of rich graph data (from biology, social networks, software analysis, semantic web) poses new challenges for reachability computation and reignites interest in discovering good reachability indices.

In the last several years, quite a few graph indexing approaches have been proposed to speed up answering reachability queries in database systems. All these approaches lie between two extreme reachability computation schemes, namely, online DFS/BFS and the complete transitive closure, and aim to balance between query time, index size, and construction cost. However, almost all of them face the scalability bottleneck for handling massive graphs, which are quickly arising from social networks (such as Twitter and WeiBo), the semantic web, and large domain ontologies (such as in the biomedical field). The majority of these approaches can only handle moderate size graphs having tens or hundreds of thousands vertices/edges; only a few barely reach the “million-vertices” threshold. Though online search methods, such as DFS/BFS, can always perform on any size graphs, their query answering time grows linearly with graph size, too costly for very large graphs.

To deal with the scalability problem, Yildirim et al. recently proposed GRAIL, which is a refined DFS utilizing auxiliary interval labeling to prune the search space. However, its overall reachability computation speedup compared with DFS is quite limited (comparable or even slower than DFS for many cases). Furthermore, though it tends to reject a “negative query” rather fast (when a vertex cannot reach another vertex), its performance for confirming a “positive query” is still a major issue as it has to discover an actual path between the queried vertices. Also, GRAIL can be one or two orders of magnitude slower for answering random queries, even more for positive queries. To sum, scalability is quickly becoming the major research challenge for reachability computation today: Can indices be constructed which scale to graphs with tens of millions of vertices and edges? Can the existing reachability indices which perform well on moderate-size graphs be scaled to very large graphs? In this paper, provided is positive answers to these questions.

Early work on reachability in the database field dates back to its application to the recursion Specifically, SCARAB (standing for SCAlable ReachABility) is proposed, a unified reachability computation framework: it not only can scale the existing state-of-the-art reachability indices, which otherwise could only be constructed and work on moderate size graphs, but also can help speed up the online query answering approaches. In the following, before proceeding to the introduction of SCARAB, first the existing reachability indexing methods are reviewed and the underlying reason for their scalability bottleneck is discussed.

1.1 Prior Work on Reachability Computation and Scalability Bottleneck

To answer the reachability query in a directed graph, it can be transformed into a directed acyclic graph (DAG) by coalescing strongly connected components into vertices and answering queries on the DAG. Since a DAG is often much smaller than the original directed graph, it is the target for reachability indexing.

Let G=(V,E) be the DAG for a reachability query, with number of vertices n=|V| and number of edges m=|E|. Numerous reachability computation approaches have been proposed and can be largely classified into three categories: transitive closure compression, hop labeling, and refined online search.

Category I (Transitive Closure Compression):

This category aims to directly compress the transitive closure TC and assign each vertex u a compressed reachable set TC(u). To determine the reachability from vertex u to v, vertex v only needs to check against TC(u). Representative methods include chain representation, interval representation, dual-labeling, path-tree, and bit-vector compression. Using interval-representation as an example, in the reachable set of a vertex u, any contiguous vertex segment is compressed to its start vertex and end vertex. For instance, if the complete transitive closure of u is {0, 1, 2, 3, 7, 8, 9}, it can be compressed into two intervals: [0, 3] and [7, 9]. The seminal work shows how to find an optimal tree for such a representation.

The latest work shows that the bit-vector compression methods, such as PWAH (Partitioned Word Aligned Hybrid compression scheme), can also significantly compress these contiguous vertex segments (considering the corresponding binary vector representation of a reachable vertex set). This category of methods is generally faster than the methods in the other two categories. Indeed, on moderate size graphs, several independent studies have demonstrated that interval representation and path-tree are the best in terms of query answering time for reachability computation. However, the basis of their success is also the very reason for their scalability bottleneck: even when the graph is sparse, as the number of vertices increases, so does the size of the materialized transitive closure, inevitably exceeding the main memory capacity. On a moderate 8-GB machine, the upper capability of most these techniques are around one million vertices. Though the compressed TC may be materialized and stored on disk, both its construction and its query performance can become prohibitively expensive due to the disk-access cost. To make things even worse, in order to produce the best compression, some of the techniques, such as tree-based interval representation, actually need to compute the complete TC first.

Category II (Hop Labeling):

The second category utilizes intermediary vertices to encode the reachability, i.e., each vertex records a list of intermediate vertices it can reach (Lₒᵤₜ) and a list of intermediate vertices which can reach it (Lᵢₙ). To answer the reachability query, a join process between the outgoing intermediate vertices of the start vertex and the incoming ones of the end vertex is performed to determine whether there is a common vertex (or one vertex in the first set can reach another in the second). Using two sets of labels, hop labeling may also be viewed as a transitive closure factorization. Compared with the first category methods, the hop labeling approaches are generally slower but can produce smaller index size.

The seminal 2-hop labeling approach proposed by Cohen et al. is the first in this category; the recent 3-hop labeling by Jin et al. utilizes a chain decomposition as the intermediary highway structure to improve the 2-hop labeling; and more recently, pathhop further generalizes 3-hop by utilizing a tree structure to replace the chain decomposition. However, all these approaches have high construction cost, which directly results in their scalability bottleneck. Specifically, in order to minimize the labeling size, the original 2-hop relies on a greedy set-cover framework, which not only involves repetitively finding densest subgraphs from a set of bipartite graphs, but also needs to materialize the entire transitive closure.

The overall construction complexity of the original 2-hop (O(n³|TC|)) is prohibitively expensive. Even with significant reduction of the construction cost by, these approaches can only handles graphs with far fewer than a million vertices.

Several heuristic approaches have been proposed to reduce 2-hop construction time. Schenkel et al. propose the HOPI algorithm, which applies a divide-and-conquer strategy to compute 2-hop labeling. Cheng et al. propose several methods, such as a geometric-based algorithm and graph partition technique, to produce a 2-hop labeling. Though their algorithms significantly speed up the 2-hop construction time, without the set-cover framework, they do not produce any approximation bound of their labeling size. Moreover, their scalability is also constrained by the lack of any good scalable partition algorithm on very large directed graphs, which these methods rely on.

Category III (Refined Online Search):

The third category of methods utilize online search to answer reachability queries; they employ auxiliary labeling information to aggressively prune the search space. Specifically, Label+SSPI and GRIPP both utilize a tree cover to speed up the DFS process. The state-of-the-art GRAIL assigns each vertex multiple interval labels; each label is generated by random depth-first traversals. The corresponding interval generated from the same DFS traversal can determine whether one vertex is likely to reach another: if Iv/⊂Iu (the interval of v is not a subset of the interval of u), then vertex u cannot reach vertex v; however, when Iv⊂Iu, it cannot be determined whether u can reach v. Thus, Iv⊂Iu is a necessary but insufficient condition for determining reachability; and multiple intervals can increase the rejection probability. GRAIL utilizes such a multi-interval labeling to prune the search space in the DFS process and has been shown to be the best online search method. It is also the only feasible scalable solution which can handle graphs with tens of millions of vertices/edges so far. The advantage of this category is that they generally do not need any optimization process and no transitive closure is needed in the construction. Its construction time and index size are both quite small, and thus can be applied to any graphs without size limitation. However, it generally has the slowest query answering time as it leaves most work to the query stage.

When the graph size becomes very large, their query performance may become too expensive to answer reachability queries. As mentioned earlier, even the state-of-the-art GRAIL has some issues on query performance.

1.2 Overview of SCARAB

To meet the scalability challenge of reachability computation on very large graphs, a novel SCARAB approach is developed, which can not only scale any of the existing reachability indices (such as methods in category I and II), but also speed up the online search methods (such as DFS and methods in category III). The basic idea of SCARAB is rather simple:
1. (Reachability Backbone) For any large graph, SCARAB first scales down the original graph by extracting a “reachability backbone” which carries the major “reachability flow” information.
2. (Accessing Backbone) To answer reachability query (u, v), start vertex u accesses a list of local outgoing backbone vertices and end vertex v accesses a list of local incoming backbone vertices. Then u (v) perform a forward (backward) local BFS in the original graph to access the reachability backbone.
3. (Reachability Join Test) Given the outgoing backbone vertex set and the incoming backbone vertex set, a “reachability join test” determines whether any outgoing vertex can reach an incoming vertex in the backbone. If yes, then u can reach v; otherwise, no. Any existing reachability computation methods can be applied to the reachability join operation on the backbone.

Interestingly, SCARAB can be employed recursively; or in other words, t a hierarchical backbone structure can be constructed. Since the single level reachability backbone is already very scalable (sufficient to handles graphs with millions of vertices) as shown in the empirical study, the hierarchical structure is not considered in this work. The reachability backbone is similar in spirit to the highway structure used in several state-of-the-art shortest path distance computation methods on road networks. However, how to construct and utilize such structure in the reachability computation has not been fully addressed. Several existing approaches have considered applying a graph partition to extract a high level structure to assist reachability computation. Unfortunately, the graph partition problem itself is known to be hard (especially on directed graphs) and lacks good scalable solution.

SCARAB needs to consider two basic research problems:
1. How can the reachability backbone be formally defined, and can it be discovered efficiently on very large graphs? Here, the backbone itself not only needs to capture the high level reachability information of the original graphs, but also has to allow the fast access for any individual vertex.
2. How the reachability backbone be utilized to compute reachability efficiently? Specifically: 1) How the backbone vertices quickly be accessed? The local search cost must be minimized; 2) How can the existing reachability index be adopted and utilized to optimize the reachability join test? For different reachability computation methods, different strategies can be taken to speed up the reachability join test.

To answer the first question, the reachability backbone to be a minimal graph structure (in terms of the number of vertices) is defined, such that for every pair of vertices which are [symbol] -hops apart in the original graph, both can access the backbone using only a local search (within [symbol] -hops), and their corresponding access vertices are connected in the backbone. In other words, the backbone structure carries all non-local reachability information. To discover the backbone, a set-cover approach is developed which can approximate the minimal backbone with guaranteed bound and a fast heuristic approach which scales almost linearly with respect to the graph size. To speed up backbone access when answering reachability query, the locally accessible backbone vertices for each vertex is materialized. For different categories of reachability computation, including online search, transitive closure compression, and hop-labeling, different strategies can be tailored for faster reachability join test using the backbone.

2. Reachability Backbone Definition

In this section, the reachability backbone is formally defined, which plays a central role in SCARAB for scaling the reachability computation. Intuitively, it is designed to have a number of desired features: 1) it should be much smaller than the original graph; 2) it should carry sufficient topological information to assist the reachability computation in the original graph; 3) it should be easy to access for any vertex in the original graph. To satisfy these features, SCARAB explicitly separates local vertex pairs from nonlocal vertex pairs, and focuses on utilizing the backbone for recovering the reachability for non-local reachable pairs. For local pairs, reachability can be computed directly online, so no global information is needed. Furthermore, the separation between local and non-local vertex pairs is determined through a threshold parameter [symbol] which can be used not only to facilitate the access of backbone vertices, but also to help control the backbone size.

Formally, given a locality threshold [symbol] , for any pair of vertices u and v, if u can reach v within [symbol] intermediate vertices, i.e., the distance between from u to v is no greater than [symbol] , then (u, v) is referred to as a local pair, and if u can reach v but through at least [symbol] +1 intermediate vertices, i.e., their distance is greater than [symbol] , then (u, v) is referred to as a non-local pair. If u cannot reach v, then, (u, v) is referred to as a unreachable pair. Given this, the reachability backbone is defined as follows:
DEFINITION 1. (Reachability Backbone) Given a DAG G=(V,E) and the locality threshold [symbol] , a reachability backbone G*=(V*,E*), where V*⊂V and E* may contain edges not in E, has the following property: for every non-local (unreachable) pair (u, v) in graph G, there must (not) exist two vertices u* and v* in V*, such that (u, u*) and (v*, v) are both local pairs in G and u* can reach v* in G*.

### Example 2.1

FIG. 5 shows a reachability backbone of graph G (FIG. 4) with [symbol] =2. As an example, for non-local vertex pair (1, 18), there is a backbone vertex 3 where vertex 1 reaches 3 in one hop, there is another backbone vertex 10 where vertex 10 reaches 18 in two hops, and vertex 3 reaches 10 in the reachability backbone. Indeed, for any non-local vertex pair in FIG. 4, you can find their corresponding local backbone vertices and they are connected in the reachability backbone (FIG. 5).

On the other hand, if two vertices cannot reach one another, no additional connection in the backbone will make them reachable from one to another. In other words, there are no false positives for reachability using the reachability backbone.

Clearly, the reachability backbone depends on the locality threshold [symbol] . As shown in the empirical study Section 5, for any real and synthetic graphs, a reachability backbone with [symbol] ≦4 can already significantly reduce the size of the original graph G by an order of magnitude. More surprisingly, for almost all the real graphs which are publicly available for reachability study, the reachability backbone even for [symbol] =2 can reduce the number of vertices by one to two orders of magnitude.

The detailed study on the selection of the locality threshold [symbol] is discussed in Section 5. Reachability Backbone Edge Set: Given a DAG G=(V,E) and its reachability backbone G*=(V*,E*), let TC(V*) be the transitive closure of G on V*, i.e., TC(V*)={(u*,v*)∈V*×V*|u*→v* in G}. Furthermore, let TC*(V*) be the transitive reduction [2] of TC(V*), i.e., TC*(V*) contains the smallest (and unique) edge set which preserve all reachability information between any two vertices in V*. Given this the following observation of the edge set E*in the reachability backbone is made:

LEMMA 1. (Backbone Edge Set) Given any reachability backbone G*=(V*,E*) for G=(V,E), E*⊂TC(V*). In other words, E* does not introduce any additional reachability information beyond those between any two vertices of V* in the original graph G. Furthermore, G*=(V*, TC*(V*)) is also a reachability backbone of G, where TC*(V*) is referred to as the canonical backbone edge set of the backbone vertex set V*. Clearly, if any additional reachability is introduced, then there is will be false positives. This violates the backbone definition.

The complete proof of Lemma 1 is omitted due to space limitation. Lemma 1 has the following important implication.

COROLLARY 1. For any candidate reachability backbone graph G*=(V*,E*) in a given graph G, where V*⊂V and E*⊂TC(V*), for any unreachable pair (u, v) in G, it will remain unreachable using G*.

This is because no additional reachability information is added in E* besides those in the original graph G, i.e., E*⊂TC(V*). Thus, there is only a need to focus on recovering the reachability for the non-local pairs in the original graph using the reachability backbone and do not have to deal with the non-reachable pairs. To facilitate our discussion, in the reminder of the paper, any valid backbone edge set E*satisfies TC*(V*)⊂E*⊂TC(V*).

### Example 2.2

In FIG. 5, the edge set of the reachability backbone is a valid backbone edge set for the backbone vertex set {3, 8, 10, 12, 16}. However, it is not a canonical backbone edge set. If the redundant edges ((8, 10) and (8, 12)) are removed, then the resulting edge set is a canonical one as any further edge removal will disconnect some reachability pair in the original graph.

Minimal Reachability Backbone (MBR): Since the reachability backbone G* aims to scale-down the original graph G, its size should be as small as possible while still maintaining its property for reachability computation. Given this, the minimal reachability backbone discovery problem is introduced: given a DAG G=(V,E) and the locality threshold [symbol] , a minimal reachability backbone is the one with the smallest number of backbone vertices, i.e., arg min_{|V}_{^{L|}}G*. Since any reachability backbone edge set E* satisfies E*⊂TC(V*), then, the backbone vertex set V* can be discovered on the graph G without defining its edge set E*. Once the backbone vertex set is discovered, E*=TC*(V*) as the default edge set can be chosen, which can be immediately computed. Thus, the MRB problem can be reformulated as follows:

DEFINITION 2. (Minimal Reachability Backbone Vertex Set (MRBVS) Discovery) Given a DAG G=(V,E) and the locality threshold [symbol] , find a minimal backbone vertex set V* ⊂V can be found such that for any non-local pair (u, v) in graph G, there must exist two vertices u* and v* in V*, such that (u, u*) and (v*, v) are both local pairs in G and u* can reach v*in G.

However, computing MRBVS is an NP-hard optimization problem because its corresponding decision problem is NP-hard.

THEOREM 1. (NP-hardness of MRBVS discovery problem) Given a DAG G=(V,E) and the locality threshold [symbol] , computing its minimal backbone vertex set is NP-hard.

3. Backbone Discovery

Since discovering the minimal backbone vertex set (MRBVS) is NP-hard, an exact solution in polynomial time cannot be expected to be found. Furthermore, based on Definition 1, even the direct verification of whether a vertex subset in V meets the backbone criterion is computationally expensive: the reachability for any non-local pair and any unreachable pair has to be explicitly verified. In this section, two backbone discovery algorithms to deal with the problem is proposed.

3.1 Backbone with Local Meeting Criterion

LEMMA 2. (Local Meeting Criterion) Given DAG G=(V,E) and a subset of vertices V*, if for any non-local vertex pair (u,v) with d(u,v)= [symbol] +1, there exists a vertex x∈V*, such that u→x, x→v with d(u,x)≦ [symbol] and d(x,v)≦ [symbol] , then V* is a reachability backbone vertex set.

Proof Sketch: Clearly, when d(u,v)= [symbol] +1, the case is trivial and u*=v*=x. Now, let d(u,v)> [symbol] +1. In that case, there is a vertex w such that d(u,w)= [symbol] +1 and w→v. Based on the postulate, a vertex x∈V* can be found such that d(u,x)≦ [symbol] and d(x,w)≦ [symbol] . Let u*=x. If d(x,v)≦ [symbol] , then v*=x. Otherwise, w′, such that d(w,v)= [symbol] +1 and x→w′ can be found. Based on the postulate, a vertex y∈V* such that d(w′,y)≦ [symbol] and d(y,v)≦ [symbol] can be found. Then v*=y. To sum, for any non-local pair (u,v), u and v in V, such that d(u,u)≦ [symbol] , d(v,v)≦ [symbol] , and u→v can be found.

Once a set of reachability backbone vertices V*, which satisfy the local meeting criterion is discovered, generating its backbone edge set E* is very easy: for each vertex u∈V*, add only edges in E* linking u to only vertices in its E-neighborhood. The following lemma guarantees that the produced graph (V*,E*) maintains the reachability information in V*, and can be used for recovering reachability between any non-local pair in the original graph.

LEMMA 3. (Reachability Backbone Edge Set with Local Meeting Criterion) Let V* be the reachability backbone vertex set which satisfies the local meeting criterion in G and E contains the edges which directly link any local-pair in V*, i.e., for any (u,v)∈E*, d(u,v)≦ [symbol] in G. Then if u→v in G (u,v∈V*), then u→v in G*=(V*,E*). In other words, TC*(V*) ⊂E*⊂TC(V*).

### Example 3.1

In FIG. 4, the vertex set {3, 8, 10, 12, 16} satisfies the local meeting criterion. Its corresponding edge set in FIG. 5 is generated based on the above method.

The proof of Lemma 3 is in the Appendix. Note that even though the local meeting criterion is very helpful in constructing a reachability backbone, not every reachability backbone vertex set has to satisfy the local meeting criterion.

### Example 3.2

Consider graph G contains two sets of vertices A and B, and any vertex pair (a, b) (a∈A and b∈B, and d(a, b)= [symbol] +1), and these pairs are linked by vertex-disjoint paths (with length [symbol] +1) and any two paths can only meet at the ends. Clearly, vertex set A∪B can be a reachability backbone vertex set (assuming there is no other vertices besides A, B and intermediate vertices in the paths linking these two sets).

However, the local meeting criterion is much easier to manage and it also provides a good collection of possible backbone vertex sets. Especially, the simple bound is observed:

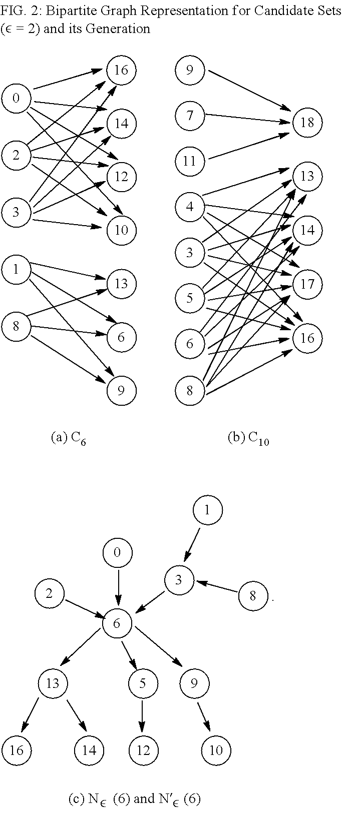

LEMMA 4. Let V [symbol] * be the minimal reachability backbone vertex set which satisfies the local meeting criterion with respect to the locality threshold [symbol] and V* be the overall minimal reachability backbone vertex set (not necessarily satisfying the local meeting criterion) with respect to the locality threshold [symbol] , then, |V [symbol] *|≧|V*|≧|V [symbol] *+1|.

Proof Sketch: It is easy to verify that any reachability backbone vertex set (not necessarily satisfying the local meeting criterion) with locality threshold [symbol] is always a reachability backbone vertex set which satisfies the local meeting criterion with respect to the locality threshold [symbol] +1. Together with Lemma 2, the bound holds.

Thus, V [symbol] * provides an upper-bound of V*. Formally, the problem of discovering the minimal reachability backbone vertex set with the local meeting criterion is referred to as the LMRBVS discovery problem and this problem for minimal reachability backbone vertex discovery will be focused upon.

THEOREM 2. (NP-hardness of LMRBVS discovery problem) Given a DAG G=(V,E) and the locality threshold [symbol] , computing its minimal backbone vertex set which satisfies the local meeting criterion is NP-hard.

Theorem 2 can be proved similarly as the proof of Theorem 1 and is thus omitted for simplicity. Though the LMRBVS discovery problem is still NP-hard, it does admit an approximation algorithm based on the set-cover frame work with guaranteed bound.

3.1.1 A Set-Cover Based Approach

Given this, it is observed the LMRBVS discovery problem can be directly coded as an instance of the set cover problem [12]: Given DAG G=(V,E) and the locality parameter [symbol] , let U={(u,v)|d(u,v)= [symbol] +1} be the ground set, which includes all the non-local pairs with distance equal to [symbol] +1. Each vertex x in the graph is associated with a set of vertex pairs Cₓ={(u,v)|d(u,x)≦ [symbol] , d(x,v)≦ [symbol] , d(u,v)= [symbol] +1}, where Cₓ includes all of the non-local pairs with distance equal to [symbol] +1, such that u can reach x and x can reach v, each within [symbol] hops. Thus, there are a total of |V| candidate sets C={Cₓ|x∈V}. Now, in order to discover the LMRBVS, sought is a subset of vertices V*⊂V, which has the minimal cardinality, to cover the ground set, i.e., U=U_{v∈V}*Cᵥ. Basically, V* serves as the index for the selected candidate sets to cover the ground set.

### Example 3.3

FIG. 2 on page 24 shows the candidate sets of vertex 6 and 10 for the graph in FIG. 4. Here, each directed edge in the bipartite graph corresponds to a non-local pair with distance 3 for locality parameter [symbol] =2.

For this set cover instance, the classical greedy algorithm to find the minimal set cover can be applied, which essentially correspond to the LMRBVS: Let R be the covered non-local pairs with distance [symbol] +1 (initially, R=). For each candidate set Cₓ in C (corresponding vertex x in V), the price of H is defined as:

$$γ ( {C}_{x} ) = \frac{1}{\vert {C}_{x} \backslash R \vert}$$

At each iteration, the greedy algorithm picks up the candidate set Cₓ (vertex x) with the minimum γ(H) (the cheapest price) and puts it into V*. Then, the algorithm will update R accordingly, R=R∪Cₓ. The process continues until no element in the ground set is uncovered: R=U. It has been proven that the approximation ratio of this algorithm is ln(|U|)+1[12].

Putting these together, the following optimality result for discovering LMRBVS is found. Its proof is omitted for simplicity.

THEOREM 3. The set-cover approach finds a reachability backbone vertex set with the local meeting criterion whose size is larger than the smallest cardinality of such a vertex set by at most O(ln(|U|)=O(ln n) factor where n is the number of vertices in the original graph G.

Computational Complexity:

The overall computational complexity of the set-cover approach is as follows. Let N [symbol] (v) and [symbol] (v) denote the vertices and the edges, respectively, in v's forward C-neighborhood. If directed edges are traversed in reserve, [symbol] (v) and E [symbol] ′(v) are the vertices and edges of the reverse neighborhoods. First, the ground set is generated by performing a local BFS on each vertex u to discover all vertices which u can reach with [symbol] +1 hops. This takes O(Σ_{v∈V}(|N [symbol] ₊₁(v)|+| [symbol] (v))|). Second, to generate all candidate sets, for each vertex u, two local BFS traversals are performed, one forward and one backward on edges (with both stopping at depth [symbol] ). FIG. 2 (c) on page 24 shows the forward and reverse ( [symbol] =2)-neighborhood for vertex 6 in the running example graph (FIG. 4) and FIG. 2(a) on page 24 is the resulting candidate set C₆. Then, any vertex pair (x,y)∈N [symbol] ′(u)×N [symbol] (u), which belongs to ground set, i.e., their distance is [symbol] +1, needs to be added to the candidate set Cᵤ. This step takes O(Σ_{v∈V}( [symbol] (v)|+| [symbol] (v)|+ [symbol] (v)|+| [symbol] (v)|+| [symbol] (v)|×| [symbol] (v)|) time. Finally, the fastest set cover algorithm [11] can perform in linear time with respect to the size of candidate sets, i.e., O(Σ_{v∈V}|Cᵥ|), where |Cᵥ|≦| [symbol] (v)|×| [symbol] (v)|.

However, large scale-free graphs may contain some vertices with high out-degree and/or in-degree, which may produce very large ground set and candidate sets and make their materialization very costly. This can become the scaling bottleneck of this approach.

3.2 Fast and Scalable Backbone Discovery

Though the set cover approach can provide good approximation of MRBVS, it can be expensive for large graphs. Here, described is a fast algorithm which need not materialize the ground set (and candidate sets) and which is very scalable, as each vertex needs to perform only a simple local BFS traversal (within e hops). Instead of relying on the local meeting criterion which has the need for two BFS traversals (forward and reverse) and a Cartesian product between two sets, this approach utilizes a slightly different one-side condition. In particular, there is only one difference between the local meeting criterion and the one-side condition: the latter targets the local vertex pair with distance e whereas the former targets the non-local vertex pair with distance [symbol] +1.

Formally, given DAG G=(V,E) and a subset of vertices V*, for a vertex pair (u, v) in G with d(u, v)= [symbol] , if there is a vertex x∈V*, such that u→x and x→v, with d(u, x)≦ [symbol] and d(x, v)≦ [symbol] , then it is said (u, v) is covered by V*. Otherwise, (u, v) is not covered by V*.

LEMMA 5. (One-side Condition) If V* can cover every vertex pair (u, v) with d(u, v)= [symbol] in G, then V* is a reachability backbone vertex set.

Proof Sketch: Based on the proof of Lemma 2, u can reach v using the backbone when d(u, v)= [symbol] +1 can be proved. Clearly, there exists a path with length [symbol] +1, such as x₀=u, x₁, . . . x [symbol] , x [symbol] +1=v. Consider are the following cases:
1) u∈V* and v∈V*: Since both V*(u→v) and the default edge E*=TC*(V*) can be utilized in the reachability backbone, thus, V* meets the criterion of reachability backbone;
2) u∈V* and v/∈V*: For vertex pair (u, x [symbol] ), there is x∈V* such that d(u, x)≦ [symbol] and d(x, x [symbol] )≦ [symbol] . Now, if d(x, x [symbol] )≦ [symbol] , then, d(x, v)≦d(x, x [symbol] )+d(x [symbol] , v)≦ [symbol] . If d(x, x [symbol] )= [symbol] , then there is a direct neighbor of x, such that d(x, y)=1 and d(y, x [symbol] )= [symbol] −1. Now, for vertex pair (y, v), there is d(y, v)= [symbol] . Thus, there must be z∈V*, such that d(y, z)≦ [symbol] and d(z, v)≦ [symbol] . Thus, there can be found x and z in V*, such that x→z and d(u, x)≦ [symbol] and d(z, v)≦ [symbol] ;
3) u∉V* and v∈V* and 4) u/∈V* and v∉V* can be proved similarly. Put together, the lemma can be proved.

Note that the test condition for the reachability backbone in Lemma 5 is referred to as one-side condition based on the following property. For any vertex u, let S [symbol] (u) contain all the vertices which u reaches using exactly [symbol] hops, i.e., S [symbol] (u)={v|d(u, v)= [symbol] }. If u∈V*, then any (u, v)∈{u}×S [symbol] (u) is covered. To facilitate our discussion, if any (u, v)∈{u}×S_{┌}(u) satisfies the one-side condition, it is said that vertex u is covered, otherwise, it is not covered.

Utilizing this property, a fast heuristic approach can be used to generate V*.

Algorithm 1 FastCover(G)

```
  1: sort vertices in V based on certain order
  2: V * ← Ø
  3: for each u ε V do
  4:  if NOT covered (u, V ) {{u} × [symbol]    (u) is uncovered} then
  5:  add u to V *
  6:  end if
  7: end for
  8: return V *;
Procedure covered (u, V *)
  9: depth (u) ← 0; distance (v) ← [symbol]     + 1;
10: add u to Q {priority queue Q ordered by topological order}
11: while Q ≠ Ø do
12:  v ← Q.pop( ) {the one with least topological order};
13:  v. visited ← TRUE;
14:  N(v) ← {W : (w, v) εE and w.visited = TRUE}; {all
end vertices of incoming edges of v}
15:  depth(v) ← min_{w εN(v)} depth(v) + 1;
16:  if v ε V * then
17:  distance(v) ← 0
18:  else
19:  distance(v) ← min_{w εN(v)} distance(v) + 1;
20:  end if
21:  if depth(v) = [symbol]     and distance(v) ≦ [symbol]     then
22:  return FALSE; {(u, v) is uncovered}
23:  end if
24:  add all v's neighbors to Q;(if they are not in Q)
25: end while
26: return TRUE; {every vertex pair in {u}× [symbol]    (u) is covered}
```

Algorithm 1 sketches the fast heuristic approach. The vertices are first ordered in certain way (determining the backbone vertex selection order). The most basic approach is to randomly order them (corresponding to an adaptive sampling procedure). Initially the reachability backbone vertex V* is an empty set (V*=). Then, for each vertex u based on the order, it is checked whether it is covered by the current reachability backbone vertex set V*, i.e., every vertex pair (u, v) where v∈S [symbol] (u) is covered. If it is not completely covered (covered(u)=FALSE), then, the vertex u is added into V*. Based on the property of one-side condition, then u is covered.

Given this, the major issue is a need to quickly determine whether a vertex u is covered. The straightforward method needs to determine that every (u,v) ∈{u}×S [symbol] (u) is covered. This is clearly very expensive. Here, described is a fast procedure which simply performs a single BFS of the neighborhood of u, i.e., G[N [symbol] (u)] which is the induced subgraph of all the vertices within [symbol] hops of u including itself Recall our goal is to check that for each vertex pair (u,v) with d(u,v)= [symbol] to be covered in V*, there exists a vertex x∈V*, such that u→x and x→v with d(u,x)≦ [symbol] and d(x,v)≦ [symbol] . It is first made sure that any vertices which are more than [symbol] hops away from u will not be visited twice. This is easily done by recording the depth of each visited vertex. Furthermore, each vertex will record a variable distance, which records the smallest distance from an already visited backbone vertex x to it. The distance of each vertex is initialized to be [symbol] +1, which suggests no backbone vertex reaches it in [symbol] steps. For any visited vertex v in V*, it is assigned distance(v)=0. In particular, the vertices can be visited based on their topological order, which has the property that for any visited vertex, all its predecessors must have been visited before. Given this, for any visited vertex v not in V*, the minimal distance of all its direct predecessors (the ends of incoming edges) are chosen and increased by one. In this way, the correct distance value for each vertex can easily be maintained. This covered procedure is sketched in Algorithm 1.

The overall computational complexity of the Fast Cover procedure (assuming using random order) is O(Σ_{u∈V}| [symbol] Nₑ(u)|log| [symbol] (u)|+| [symbol] (u)|). For random graphs with average vertex degree d, the time complexity can be written as O(n [symbol] log dd [symbol] ). Since this algorithm does not need to materialize the ground set and candidate sets, there is no scalability bottleneck and the algorithm scales linearly with respect to the graph size.

In addition, it is noted that there are many ordering strategies for determining the selection order of backbone vertices (besides the random ordering). Especially, it is found that the vertex order based on the product of vertex in-degree and out-degree is particularly effective for producing the reachability backbone on very large graphs. Though the Fast Cover does not provide any approximation bound, using this order strategy, this approach in most of the cases (in the empirical study) can discover the backbone vertex set with size being quite comparable to the set-cover approach (Section 5). Thus, this ordering strategy is adopted for Fast Cover. Note is that such ordering will introduce an additional O(|V|log|V|) sorting time complexity. However, for real world large graphs, most of the products of vertex in-degree and out-degree are expected to be less than O(|V|) due to the scale-free property. Given this, the counting sort for the majority of vertices is utilized and thus empirically reduces the ordering cost to approximately O(|V|).

Finally, it is also rather easy to construct the edge set for the reachability backbone vertex set with the one-side condition:

LEMMA 6. Let V* be the reachability backbone vertex set which satisfy the one-side meeting criterion in G and E* contain the edges which directly link any local-pair in V* and all the non-local pairs with distance [symbol] +1 in V*. Then if u→v in G(u,v∈V*), the u→v in G*=(V*,E*).

Note that the only difference between this lemma and Lemma 3 is that this one has to directly link non-local pairs with distance [symbol] +1, whereas Lemma 3 does not need. The reason can be observed in the first case in the proof of Lemma 5. Basically, there is possibility that two backbone vertices can be [symbol] +1 hops away and there is no other backbone vertices between them. The proof of Lemma 6 is similar to Lemma 3 and is omitted for simplicity.

4. Reachability Computation Via Reachability Backbone

Using the reachability backbone G* to compute a reachability query consists of two basic steps:

1. Local Search for Accessing Backbone:
First, two local BFS are performed (within [symbol] depth from the starting vertex) in the original DAG G: the forward BFS from u to collect [symbol] ₒᵤₜ(u), the set of all backbone vertices which u can reach within [symbol] hops, i.e. [symbol] ₒᵤₜ(u)={x∈V*|d(u, x)≦ [symbol] }=V*∩ [symbol] (u); and the reversed BFS from v to collect [symbol] ᵢₙ(v), the set of all backbone vertices which can reach v within [symbol] hops, i.e., [symbol] ₒᵤₜ(v)={y ∈V*|d(y, v)≦ [symbol] }=V*∩N′ [symbol] (v). Note that during the forward BFS (or reversed BFS), also it can be checked whether u reaches v locally (d(u, v)≦∈), and if it is, the reachability can be confirmed.

2. Reachability Join Test:
[symbol] ₒᵤₜ(u)→ [symbol] ᵢₙ(v): The reachability join test [symbol] ₒᵤₜ(u)→ [symbol] ᵢₙ(v) in the reachability backbone G* determines whether there exists x∈ [symbol] ₒᵤₜ(u) and y∈ [symbol] ᵢₙ(v), such that x→y in G*. If it is then u→v in G and not otherwise. Given this, there is a need to compute the reachability between any (x, y)∈ [symbol] ₒᵤₜ(u [symbol] ᵢₙ(v). Due to the modest size of the reachability backbone, any of the existing reachability indices and computational methods can be used.

Algorithm 2 Basic Reach(u,v)

Parameter: G * is the reachability backbone
1: perform two BFS to compute [symbol] ₒᵤₜ(u)and [symbol] ᵢₙ(v);
2: for each x ε [symbol] ₒᵤₜ(u)do
3: for each y ε [symbol] ᵢₙ(t)do
4: if Reach(x,y|G *) then
5: return TRUE;
6: end if
7: end for
8: end for
9: return FALSE;

The basic reachability computation scheme is sketched in Algorithm 2. Note that Reach(x, y|G*) is the generic reachability computation method (such as those describe in Section 1) in the reachability backbone G*. In the following, strategies and refinement to speed up the basic computation scheme will be discussed. Specifically, in Subsection 4.1, discussed is the optimization strategies to utilizing the transitive closure compression and hop-labeling approach. Then in Subsection 4.2, described is how online search and GRAIL can be better adopted in this query scheme.

4.1 SpeedUpQueryProcessing

This subsection is focused on optimization strategies for the reachability indexing approaches: the transitive closure compression (category I) and hop-labeling approach (category II) which are applied to the reachability backbone G*. Specifically, for any method in the first category, each vertex x in the reachability back-bone G* is assigned a compressed transitive closure TC(x) (different methods utilize different compression strategies) and to compute Reach(x,y|G*), a search procedure quickly determines whether y ∈TC(x); for any method in the second category, each vertex x is assigned two labeling sets Lₒᵤₜ(x)⊂V* (some vertices which x can reach) and Lᵢₙ(x)⊂V* (some vertices which reach x). To compute Reach(x,y|G*), Lₒᵤₜ(x) is searched against Lᵢₙ(y) to see whether there is a common vertex[10](or there is a common chain[15,4]) which can link x to y.

Given this, the performance of Algorithm 2 is determined by these two steps for any reachability query (?u→v):
1) the two local BFS compute the backbone access vertex sets [symbol] ₒᵤₜ(u) and [symbol] ᵢₙ(v) and one of them is used to determine whether the start vertex can reach the end vertex locally. Here, the potential problem is that BFS may potentially scan a large number of vertices and edges, especially when there are hub vertices (incoming or outgoing) in the [symbol] -neighborhood.
2) the cost of the reachability join test is determined by the number of reachability pair queries. In the basic scheme, there is a need to compute | [symbol] ₒᵤₜ(u)|×| [symbol] ᵢₙ(v))| pairs, which can be expensive.

Access Vertex Materialization and Reduction:

To address these two problems, our first strategy is to explicitly materialize the backbone access vertex sets for each vertex u. This is because the number of those vertices is generally quite small. Interestingly, the actual materialized vertex set can be even smaller: given DAG G and its reachability backbone V*, for each vertex u, the following two backbone access vertex sets need to be materialized:
[symbol] ₒᵤₜ(u)={v∈V|d(u,v)≦ [symbol] and there is no other vertex x, in V* such that d(u,x)≦ [symbol] d(x,v)≦ [symbol] (u→x→v)}
[symbol] ᵢₙ(u)={v∈V|d(v,u)≦ [symbol] and there is no other vertex y, in V* such that d(v,y)≦ [symbol] d(y,u)≦ [symbol] (v→y→u)}

LEMMA 7. (Access Vertex Reduction) For any reachability query (?u→v), when (u,v) is a non-local pair, it is sufficient to perform reachability join test between [symbol] ₒᵤₜ(u) and [symbol] ᵢₙ(v), i.e., [symbol] ₒᵤₜ(u)→ [symbol] ᵢₙ(v), to determine whether u can reach v.

Intuitively, Lemma 7 suggests that if a backbone vertex in V* is accessed, then none of its successors (according to visit order) need to be considered in the reachability join test. This is because those pruned vertices areal ready in the backbone and can be accessed by those “first-accessed” ones. Therefore there is no need to record or utilize them in the reachability join test. Due to the space limitation, the proof of Lemma 7 is not included. Since | [symbol] ₒᵤₜ(u)|≦| [symbol] ₒᵤₜ(u)| and | [symbol] ᵢₙ(v)|≦ [symbol] ᵢₙ(v) for any vertex pair, this strategy can reduce the cost not only of online search but also of reachability join test.

Online Pruning: The second strategy targets directly the reach-ability join test. If x→y can be quickly rejected, where x∈ [symbol] ₒᵤₜ(u) and y∈ [symbol] ᵢₙ(v), then is not a need to actually perform Reach(x,y|G*), which either involves searching through the compressed transitive closure of x, TC(x) (in Category I) or comparing two labeling sets Lₒᵤₜ(x) and Lᵢₙ(y) (in Category II). Furthermore, if x→v can be quickly rejected, then the reachability tests against all vertices in [symbol] ᵢₙ(v) can be directly avoided.

To achieve such goal, the interval labeling method in GRAIL [24] is used. Basically, each vertex u in the entire graph G is assigned multiple interval labels [symbol] ᵤ which can help to determine quickly the non-reachability between two vertices. These labels are generated by performing a constant number(c) of random depth-first traversals, i.e., the visiting order of the neighbors of each vertex is randomized in each traversal. Each traversal will produce one interval for every vertex in the graph. Such interval labeling has the property that if [symbol] ᵥ/⊂ [symbol] ᵤ, then vertex u cannot reach vertex v. However, when [symbol] ᵥ⊂ [symbol] ᵤ, it cannot determined whether u can reach v. GRAIL utilizes this labeling in the depth-first search to prune the search space. Such a labeling can be constructed very fast (O(c(n+m))) and its index size is only O(cn), where c can be quite small (c=5 is shown to be sufficient to provide good pruning).

Such labeling is used to help quickly reject any (x,y) pairs in [symbol] ₒᵤₜ(u)× [symbol] ᵢₙ(v) and any vertex x which cannot lead to u→v. Reach(x,y|G*) is explicitly computed only if such a test cannot be pruned using the multi-interval labeling. Note that for the hop-labeling approach (Category II), an alternative strategy exists which can directly avoid the explicit the pair-wise reachability computation. The idea is to first merge all the Lₒᵤₜ(x) for x ∈ [symbol] ₒᵤₜ(u) and Lᵢₙ(y) for all y∈ [symbol] ᵢₙ(v), and then perform a comparison between the two merged lists. However, since the merge cost is actually quite expensive, it was found that this method is actually much slower than explicit pair wise comparison together with the online pruning method. Explicit pair wise comparison's early termination (when the first x→y is confirmed) turns out to be quite effective. Thus, the merge strategy is not adopted here.

Bidirectional Local Search:

Though there is no need to perform the online BFS to collect the reachability backbone access vertices, whether u can reach v locally, i.e., d(u,v)≦ [symbol] still needs to be determined. To perform such a local test, a bidirectional BFS can be used to reduce the search space. Specifically, the forward BFS starting at u needs to expand to at most ┌ [symbol] /2┐ depth and the reversed BFS starting from v needs to expand to └ [symbol] /2┘ depth. Furthermore, in either BFS expansion, if a reachability backbone vertex (in V*) is visited, then it is not needed to further expand its outgoing (or incoming) vertices, a considerable savings for hub vertices. Hub vertices (a vertex either with high in-degree or out-degree) tend to be covered in the reachability backbone vertex set. Indeed, if they are not covered, they are explicitly added to the reachability backbone. Since the number of hub vertices tend to be quite small, this strategy can help reduce the cost of local search while not greatly expanding the backbone size.

Algorithm 3 FastReach(u,v)

```
Parameter: G *is the reachability backbone
  1: Bidirectional online BFS search from u and v;
  2: if meet then
  3:  return TRUE
  4: end if;
  5: for each x ε [symbol]    ₒᵤₜ(u) do
  6:  if Iᵥ ⊂ Iᵤthen
  7:  for each y ε [symbol]    ᵢₙ(t) do
  8:  if Iᵥ ⊂ Iᵤ then
  9:  if Reach(x,y|G*) then
10:  return TRUE;
11:  end if
12:  end if
13:  end for
14:  end if
15: end for
16: return FALSE;
```

The query processing algorithm which incorporates the above optimization strategies is sketched in Algorithm 3. Clearly, its worst case computational complexity can be partitioned into two parts (O(T1+T2)). T1 comes from the bidirectional local search, where T1=max_{u,v∈V}(| [symbol] |+| [symbol] |)+max_{U,v∈V}(|N′_{[} [symbol] _{/2]}(v)|+|E′_{┌} [symbol] _{/2┐}|). T₂ is the cost of the reach ability join test, given by max_{u,v∈V}| [symbol] ₒᵤₜ(u)|×| [symbol] ᵢₙ(v)|×T₃≦max_{u,v∈V}| [symbol] (u)|×| [symbol] (v)|×T₃, where T₃ is the worst case complexity of different reachability computational methods in the reachability backbone G*. Recall that | [symbol] ′(v)|( [symbol] (v)|) is the number of vertices (edges) in v's reversed [symbol] -neighborhood. For instance, consider Agrawal et al.'s tree-interval[1] is used to compress the transitive closure in the reachability backbone and let n′=|V*|, and assume the original graph is a random DAG with average in-degree and out-degree d, then the worst case computational complexity of FastReach can be simplified to O( [symbol] +d² [symbol] log n). As will shown in Section 5, the actual number of Reach invocations is much smaller than [symbol] and can be treated as constant (it is also a local measure). Thus, the worst case query computational complexity can be effectively scaled down and directly relates to the size of the reachability backbone.

4.2 Speed Up Online Search

The FastReach query processing scheme can be applied to the (refined) online search methods (Category III) such as GRAIL. Basically, each invocation of Reach(x,y|G*) needs to perform an independent GRAIL search. However, this is clearly very expensive as each search needs to travel a large search space in G* and the search spaces of different invocations can even overlap. Furthermore, assuming both y1 and y2 in [symbol] ᵢₙ(v), and x∈ [symbol] ₒᵤₜ(u), it may happen during Reach(x,y1|G*), it may reach y2 even though x cannot reach y1. Finally, for the online search method, the cost of local online search (for collecting access vertices in the reachability backbone) compared with the search in the reachability backbone is quite small. Thus, the need to actually materialize them is small.

Given this, OnlineSearch is proposed to deal with these issues and consists the following main steps:
1. Perform a reversed BFS from v and for each visited reachability backbone vertex y∈V*, flag it to be “target”. If u is visited, return TRUE;
2. Perform a forward BFS from u and if any visited vertex x is a reachability backbone vertex x∈V*, then perform a online search (recursive) from u in G*:
   2.1. if the current visited vertex x is already visited before (visit[x]=TRUE), then return (traceback);
   2.2. if the current visited vertex x is a target(target[x]=TRUE), then return TRUE;
   2.3. recursively visited all x's neighbors.
3. return FALSE;

Basically, all the different searches starting from different backbone access vertices (in 2.) can be considered as a single recursive graph traversal. To answer a reachability query (u, v), any vertex in G* will be visited at most once. This is because all the backbone vertices which reach v within [symbol] steps are first flagged. Thus, if a vertex is already visited in the earlier search, then it basically has no chance to reach any of the flagged backbone vertices and no need to revisit them. Also, during the forward and reverse BFS, if a backbone vertex is visited, then there is no need to further explore it (similar to Lemma 7). In addition, it is noted for the refined online search, such as GRAIL, the interval labeling in both BFS in the original graph and recursive search in the reachability backbone search can be used. For instance, in the reversed BFS, it is only needed to visit vertex y such that [symbol] ᵥ⊂ [symbol] ᵤ, and in both forward BFS and online recursive search, it is only needed to visit vertex x such that [symbol] ᵥ⊂ [symbol] ᵤ. Finally, it is noted that if the computational cost of the online recursive search is focused on, as it is usually the dominant one, then the worst-case computational complexity of OnlineSearch is O(n+m), where n=|V*| and m=|E*| for any refined online search method[24,5,21].

The above description and associated figures teach the best mode of the invention. The following claims specify the scope of the invention. Note that some aspects of the best mode may not fall within the scope of the invention as specified by the claims. Those skilled in the art will appreciate that the features described above can be combined in various ways to form multiple variations of the invention. As a result, the invention is not limited to the specific embodiments described above, but only by the following claims and their equivalents.

What is claimed is:

1. A method for scaling reachability computations on relatively large graphs, the method comprising:
identifying an initial graph comprising a plurality of vertices and a plurality of edges;
identifying a backbone graph within the initial graph at least in part by a graph creation module;
creating a subsequent graph comprising a scaled-down version of the initial graph, based at least in part on the backbone graph, at least in part by the graph creation module; and
computing the reachability of at least two of the vertices using at least the subsequent graph at least in part with a processor and a reachability analytics module.

2. The method of claim 1, wherein the plurality of vertices classified as either local or non-local based at least in part on a locality threshold, wherein the relationship of the local vertices is below the locality threshold and the relationship of the non-local vertices is above the threshold.

3. The method of claim 2, wherein the computing the reachability of local vertices is accomplished at least in part using a bidirectional breadth first search of the initial graph and/or the subsequent graph.

4. The method of claim 2, wherein the subsequent graph comprises non-local relationships of the plurality of vertices.

5. The method of claim 3 or 4, wherein the computing the reachability of at least two vertices is accomplished at least in part using the initial graph, and if the reachability of the two vertices cannot be computed using at least the initial graph and based at least in part on local relationships, computing the reachability of the at least two vertices using at least the subsequent graph.

6. The method of claim 5, wherein a reachability of a first processed vertice of the at least two vertices, is based at least in part on a function of vertices that can be reached by the first vertice.

7. The method of claim 5, wherein computing the reachability of a first vertice of the at least two vertices, is accomplished at least in part using a function of vertices which can reach a second vertice.

8. The method of claims 7, wherein a reachability of the at least two vertices is the Cartesian product of the function of vertices the first vertice can reach and a function of vertices that can reach the second vertice.

9. The method of claims 6 and 7, wherein a reachability of the at least two vertices is determined in part on whether the at least two vertices can reach the backbone.

10. The method of claim 1, wherein the identifying the backbone graph is accomplished at least in part by a set cover method.

11. The method of claim 1, wherein the identifying the backbone graph is accomplished at least in part by a fast cover method.

12. One or more computer readable storage media having program instructions stored thereon for scaling reachability computations on relatively large graphs that, when executed by a computing system, direct the computing system to at least:
identify an initial graph comprising a plurality of vertices and a plurality of edges;
identify a backbone graph within the initial graph at least in part by a graph creation module;
create a subsequent graph comprising a scaled-down version of the initial graph, based at least in part on the backbone graph at least in part by the graph creation module; and
compute the reachability of at least two of the vertices using at least the subsequent graph at least in part with a processor and a reachability analytics module.

13. The one or more computer readable storage media of claim 12, having further instructions which cause the computing system to, wherein the computing the reachability of at least two vertices is accomplished at least in part using the initial graph, and if the reachability of the two vertices cannot be computed using the initial graph, computing the reachability of the at least two vertices using at least the backbone graph.

14. The one or more computer readable storage media of claim 12, having further instructions wherein a relationship of the plurality of vertices is determined at least in part on a locality threshold, where local vertices are below the locality threshold and non-local vertices are above the locality threshold.

15. The one or more computer readable storage media of claim 14, having further instructions which cause the computing system to compute the reachability for local vertices from the initial graph, and the non-local vertices in the backbone graph.

16. The one or more computer readable storage media of claim 15, having further instructions wherein the computing the reachability of local vertices is accomplished at least in part using a bidirectional breadth first search of the initial graph and/or the backbone graph.

17. The one or more computer readable storage media of claim 12, having further instructions wherein the creating a scaled-down backbone graph is accomplished at least in part via a set cover or fast cover function.

18. The one or more computer readable storage media of claim 12, having further instructions which cause the computing system to wherein the reachability of the at least two vertices is determined in part on whether the at least two vertices can be reached by the backbone.

19. A method for scaling reachability computations on relatively large graphs, the method comprising:
identifying an initial graph comprising a plurality of vertices and a plurality of edges;
creating a scaled-down backbone graph of the initial graph based at least in part on a locality threshold; and
computing the reachability of at least two of the plurality vertices using at least the initial graph or the backbone graph.

20. The method of claim 19, wherein the creating a scaled-down backbone graph is accomplished at least in part via a set cover or fast cover function.
